(19) United States
(12) Patent Application Publication
(10) Pub. No.: US 2023/0306383 A1
(43) Pub. Date: Sep. 28, 2023

(54) RECYCLING WORK SUPPORT SYSTEM

(71) Applicant: HONDA MOTOR CO., LTD., Tokyo (JP)

(72) Inventors: Shoji INOSE, Saitama (JP); Katsuyuki AWANO, Saitama (JP); Satoshi HIRAWAKI, Saitama (JP); Kazuo TAKEUCHI, Saitama (JP)

(21) Appl. No.: 18/177,133

(22) Filed: Mar. 2, 2023

(30) Foreign Application Priority Data
Mar. 22, 2022 (JP) 2022-045108

(51) Int. Cl. G06Q 10/30; G06Q 10/0631

(52) U.S. Cl. CPC G06Q 10/30; G06Q 10/063112

(57) ABSTRACT

Provide is a recycling work support system capable of improving efficiency of recycling and enhancing the economic value of an article to be recycled. A recycling work support system includes: a recommended disassembly-target part decider for deciding disassembly-target parts to be disassembled in disassembly work and/or a disassembly procedure for the disassembly work so that a total of resource prices for parts that can be disassembled per predetermined time is high, based on the resource prices of the materials, recovery amounts of the materials, and the working hours; and a recommended disassembly-target part displayer for displaying the decided disassembly-target parts to be disassembled and/or disassembly procedure to workers who are to perform the disassembly work.

### This application is based on and claims the benefit of priority from Japanese Patent Application No. 2022-045108, filed on 22 Mar. 2022, the content of which is incorporated herein by reference.

### BACKGROUND OF THE INVENTION

### Field of the Invention

The present invention relates to a recycling work support system.

### Related Art

Technologies for reusing or recycling articles are currently proposed for the purpose of effective use of resources and environmental measurements (see, for example, Japanese Unexamined Patent Application, Publication Nos. 2020-154394 and 2004-249253).

Japanese Unexamined Patent Application, Publication No. 2020-154394 discloses a system that automatically identifies, based on a recovered product database, composite composition information about an article to be processed, which is to be reused, and automatically determines optimized reuse processing conditions based on the composite composition information, for the purpose of promoting reuse of merchandise.

Japanese Unexamined Patent Application, Publication No. 2004-249253 discloses a system that, upon receiving article disassembly information, produces one of a plurality of disassembly drawings that can be produced based on the received article disassembly information in accordance with a progress state of disassembly work of an article to be recycled, and displays the produced disassembly drawing on a display device, for the purpose of efficiently performing the disassembly work of the article.

Patent Document 1: Japanese Unexamined Patent Application, Publication No. 2020-154394

Patent Document 2: Japanese Unexamined Patent Application, Publication No. 2004-249253

### SUMMARY OF THE INVENTION

However, equipment of disassembly workers and time resources that can be used for one article to be recycled are limited. Therefore, not only improvement of energy efficiency and work efficiency but also enhancement of economic value as a result of disassembly work is desired.

In view of the foregoing circumstances, an object of the present invention is to provide a recycling work support system capable of improving efficiency of recycling and enhancing the economic value of an article to be recycled.

A recycling work support system (for example, a recycling work support system 1 described later) according to an aspect of the present invention includes: an article identifier (for example, an article identifier 211 described later) configured to identify a kind of an article to be recycled, based on external appearance information and/or identification information about the article; an article information storage (for example, a recycling database 221 described later) configured to store article information about the article identified by the article identifier, the article information including parts of the article, materials of the parts, amounts of the materials, and working hours required to remove each of the parts; a material price acquirer (for example, a material price acquirer 212 described later) configured to acquire resource prices of the materials of the parts; a recommended disassembly-target part decider (for example, a recommended disassembly-target part decider 213 described later) configured to decide disassembly-target parts to be disassembled in disassembly work and/or a disassembly procedure for the disassembly work so that a total of resource prices for parts that can be disassembled per predetermined time is high, based on the resource prices of the materials, recovery amounts of the materials, and the working hours; and a recommended disassembly-target part displayer (for example, a recommended disassembly-target part displayer 214 described later) configured to display the decided disassembly-target parts and/or disassembly procedure to workers who perform the disassembly work.

The recommended disassembly-target part decider notifies a purchase price for the parts that can be disassembled per predetermined time by subsequent disassembly work or notifies that the purchase price for the parts that can be disassembled per predetermined time has become equal to or lower than a predetermined value.

The recycling work support system further includes a disassembled part identifier (for example, a disassembled part identifier 215 described later) configured to identify parts disassembled by the workers. In a case where the parts identified by the disassembled part identifier are different from the disassembly-target parts or disassembly procedure displayed by the recommended disassembly-target part displayer, the recommended disassembly-target part decider newly decides subsequent disassembly-target parts or disassembly procedure.

The recommended disassembly-target part decider corrects the working hours required to remove each of the parts based on at least one selected from equipment of the workers, the number of the workers and a degree of skills of the workers.

The recommended disassembly-target part decider decides the disassembly-target parts and/or the disassembly procedure for the disassembly work further based on a degree of difficulty of removal work for each of the parts.

In a case where a total of purchase prices for parts obtained by the disassembly work is higher than a decided value, the recommended disassembly-target part decider feeds back the disassembly-target parts and the working hours to decision of subsequent disassembly-target parts and/or disassembly procedure for disassembly work.

The recycling work support system further includes a feedback information storage (for example, a feedback information 222 described later) configured to store viewer evaluations that are evaluations by a viewer about the disassembly-target parts and the disassembly procedure fed back and the disassembly-target parts and the disassembly procedure stored. The recommended disassembly-target part displayer preferentially displays disassembly-target parts and/or a disassembly procedure with a relatively high value of the viewer evaluation.

The recommended disassembly-target part decider decides which parts of which article to be recycled are to be disassembled, based on a predetermined unit time amount, identification information about all articles to be recycled for which disassembly work can be performed in the predetermined unit time amount, and at least one selected from equipment of, a number of, and a degree of skills of the workers.

The recycling work support system further includes a sending destination decider (for example, a sending destination decider 216 described later) configured to decide, based on kinds of the parts identified by the disassembled part identifier, the amounts of the materials of the parts stored in the article information storage, and a requested sending amount of each material that can be sent into each of one or more sending destinations, a sending destination of each of the parts, and display the decided sending destination of the part to the workers.

According to the present invention, it is possible to provide a recycling work support system capable of improving efficiency of recycling and enhancing the economic value of an article to be recycled.

### BRIEF DESCRIPTION OF THE DRAWINGS

FIG. 1 is a diagram showing an example of a configuration of a recycling work support system according to an embodiment;

FIG. 2 is a diagram showing an example of a configuration of a work support apparatus;

FIG. 3 is a diagram showing an example of resource prices;

FIG. 4 is a diagram showing an example of resource prices;

FIG. 5 is a diagram showing an example of sending parts into two containers as part sending destinations;

FIG. 6 is a diagram showing an example of sending parts into two containers as part sending destinations; and

FIG. 7 is a flowchart showing a process performed by the work support apparatus according to the present embodiment.

### DETAILED DESCRIPTION OF THE INVENTION

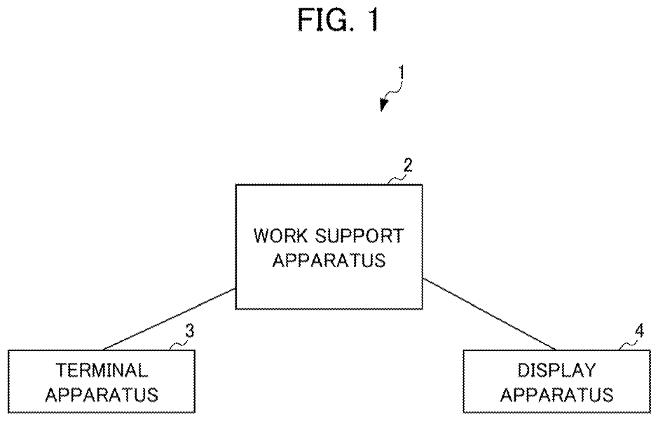

An embodiment of a recycling work support system of the present invention will be described below with reference to drawings. FIG. 1 is a diagram showing an example of a configuration of a recycling work support system 1 according to the present embodiment. As shown in FIG. 1, the recycling work support system 1 is provided with a work support apparatus 2, a terminal apparatus 3, and a display apparatus 4.

The work support apparatus 2 is a computer apparatus for supporting workers who perform vehicle disassembly work. The work support apparatus 2 is communicable with the terminal apparatus 3 and the display apparatus 4. A specific configuration of the work support apparatus 2 will be described later. A vehicle to be disassembled is, for example, a four-wheeled vehicle, a motorcycle, a bicycle or the like driven by an internal combustion engine and/or by electricity.

The terminal apparatus 3 is wirelessly and/or wiredly communicable with the work support apparatus 2, acquires external appearance information and/or identification information about an article constituting a vehicle to be recycled, and transmits the acquired external appearance information and/or identification information to the work support apparatus 2.

The terminal apparatus 3 may have an imager to pick up an image of the article as the external appearance information, and may have an imager such as a camera or a scanner to acquire a barcode or a two-dimensional code (for example a QR code (registered trademark)) associated with model information about the vehicle to be disassembled, from a vehicle inspection certificate or the like as the identification information.

The display apparatus 4 is wirelessly and/or wiredly communicable with the work support apparatus 2, and displays information provided from the work support apparatus 2 to workers who are to perform disassembly work. The display apparatus 4 may be, for example, a display like an LCD and an organic electroluminescent display, a projector, a smartphone, a tablet terminal, monitor goggles, AR (augmented reality) goggles or the like.

For example, when a worker wearing AR goggles visually confirms a part of an article that is being disassembled, the AR goggles as the display apparatus 4 may display disassembly-target parts to be disassembled in disassembly work and/or a disassembly procedure for the disassembly work in such a manner as to superimpose the disassembly-target parts and/or the disassembly procedure on the part of the article that is being disassembled, by projection mapping. Alternatively, an apparatus for notifying the worker by voice may be used instead of the display apparatus 4.

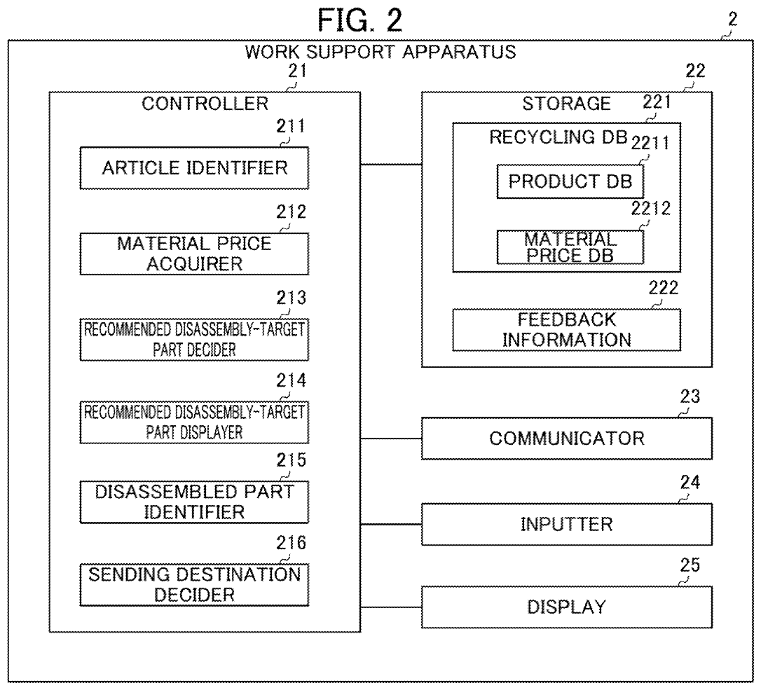

FIG. 2 is a diagram showing an example of a configuration of the work support apparatus 2. As shown in FIG. 2, the work support apparatus 2 is provided with a controller 21, a storage 22, a communicator 23, an inputter 24 and a display 25.

The controller 21 is realized, for example, by a hardware processor such as a CPU (central processing unit) executing a program (software). A part or all of these components may be realized by hardware (including circuitry) such as an LSI (large scale integration), an ASIC (application specific integrated circuit), an FPGA (field-programmable gate array) or a GPU (Graphics processing unit) or may be realized by cooperation by software and hardware.

The program may be stored in a storage device (a storage device provided with a non-transitory storage medium) such as an HDD (hard disk drive) or a flash memory in advance, or may be stored in a removable storage medium (a non-transitory storage medium) such as a DVD or a CD-ROM and installed when the storage medium is fitted in a drive device.

The storage 22 is realized, for example, by a storage device provided with a non-transitory storage medium, such as an HDD (hard disk drive), a flash memory, an EEPROM (electrically erasable programmable read-only memory) or a ROM (read-only memory), or a RAM (random access memory) or the like.

The communicator 23 is a communication interface for communicating with external equipment via a network. The inputter 24 is an input interface like a mouse, a keyboard and the like. The display 25 is a device to display an image. The display 25 is for example, an LCD (liquid crystal display) or an organic EL (electroluminescence) display.

The controller 21 is provided with an article identifier 211, a material price acquirer 212, a recommended disassembly-target part decider 213, a recommended disassembly-target part displayer 214, a disassembled part identifier 215, and a sending destination decider 216. The storage 22 stores a recycling database 221 and feedback information 222.

The recycling database (DB) 221 has a product database 2211 and a material price database 2212.

The product database 2211 stores article information about each article, for example, at least parts of the article, materials of the parts, amounts of the materials, working hours required to remove each of the parts, vehicle model information, information about vehicle parts and/or materials, and part assembly information.

Here, the time required to remove each of the parts includes a preparation period for movement of workers, change of tools, work for removal of incidental parts, and the like. The vehicle model information is acquired from a QR code (registered trademark) on a vehicle inspection certificate, by input from the terminal apparatus 3 or the like. The information about vehicle parts and/or materials is acquired from vehicle or article drawing information, MOCS (mobile operation control systems) or the like. The part assembly information is acquired from vehicle and/or part manufacturing manuals, service manuals, and the like.

The material price database 2212 stores materials of parts, and purchase prices of the materials acquired by the material price acquirer 212. The materials of parts, and the purchase prices of the materials may be inputted by the terminal apparatus 3 or the like and stored in the material price database 2212 in advance.

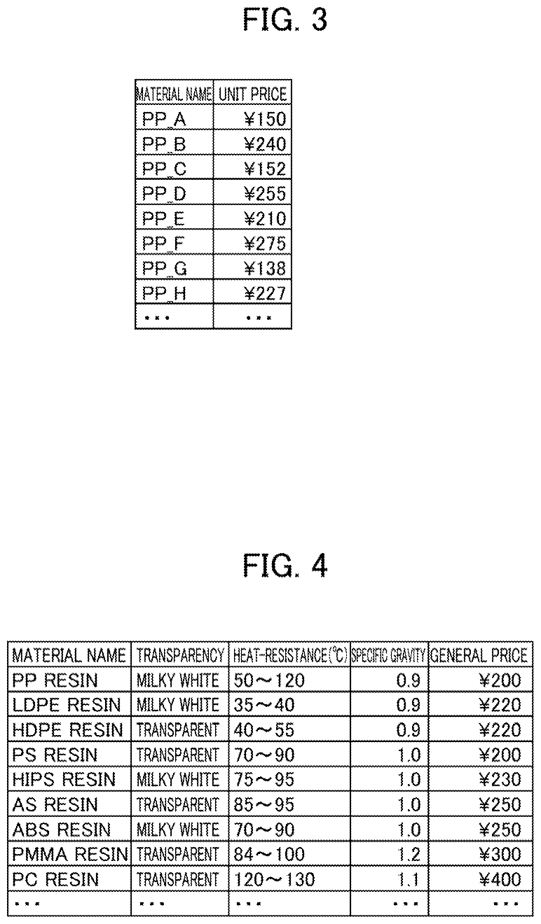

FIGS. 3 and 4 are diagrams showing examples of resource prices. FIG. 3 shows an example of a database that stores purchase prices of materials included in parts as the resource prices. The database shown in FIG. 3 stores names of the materials included in parts and the purchase prices of the materials, associating the names and the purchase prices, respectively. The material price acquirer 212 can acquire purchase prices of materials of parts of an article from such a database as shown in FIG. 3. The database as shown in FIG. 3 may be stored inside the work support apparatus 2 or may be outside the work support apparatus 2.

FIG. 4 shows an example of a website showing purchase prices of materials included in parts as the resource prices. The website shown in FIG. 4 stores names of materials included in parts, purchase prices of the materials, and characteristics of the materials, associating the names, the purchase prices, and the characteristics, respectively. The material price acquirer 212 can acquire purchase prices of materials of parts of an article from such a website as shown in FIG. 4. The material price acquirer 212 may acquire purchase prices by a program like a bot, which automatically acquires the purchase prices from a website as shown in FIG. 4, or may acquire the purchase prices in a predetermined cycle or at predetermined time.

Returning to FIG. 2, the article identifier 211 acquires external appearance information and/or identification information about an article to be recycled, from the terminal apparatus 3, and identifies the kind of the article based on the acquired external appearance information and/or identification information about the article. Here, the external appearance information about the article may be, for example, an image obtained by picking up an image of the external appearance of the article or a part of the article. The identification information about the article may be, for example, a one-dimensional or two-dimensional code like a barcode or a QR code (registered trademark).

The material price acquirer 212 acquires resource prices (for example, purchase prices) of materials of parts of the article. The material price acquirer 212 stores the acquired purchase prices of the materials into the material price database 2212.

The recommended disassembly-target part decider 213 decides disassembly-target parts to be disassembled in disassembly work and/or a disassembly procedure for the disassembly work so that a total of resource prices (for example, purchase prices of materials*material recovery amounts) for parts that can be disassembled per predetermined time is high, based on the resource prices (for example, the purchase prices) of the materials, recovery amounts of the materials, and working hours for disassembly work stored in the product database 2211 of the recycling database 221.

Specifically, the recommended disassembly-target part decider 213 may make a judgment about whether material recovery is to be performed or not for each of parts of the article judged by the article identifier 211, using parameters stored in the recycling database 221 and the following formula. Judgment value X about whether recovery is to be performed or not

=(value of material)/(processing cost for disassembly work)=(purchase price of material×material recovery amount)/(labor cost for disassembly work×working hours) (1)

In Formula (1), the value of the material is indicated by (purchase price of material×material recovery amount), and the processing cost for disassembly work is indicated by (labor cost for disassembly work×working hours).

That is, the recommended disassembly-target part decider 213 judges that material recovery is to be performed for the part of the article if the judgment value X about whether recovery is to be performed or not is equal to or larger than 1, and judges that material recovery is not to be performed for the part of the article if the judgment value X about whether recovery is to be performed or not is smaller than 1.

If there are a plurality of articles for which the material is to be recovered, the recommended disassembly-target part decider 213 decides a part for which the judgment value X about whether recovery is to be performed or not is the largest, among parts judged to be recovered, that is, such a part that the material value per working hour is the largest as a disassembly-target part to be disassembled in the disassembly work.

Furthermore, together with the judgment about whether recovery is to be performed or not, the recommended disassembly-target part decider 213 decides disassembly-target parts to be disassembled in the disassembly work and/or a disassembly procedure for the disassembly work, based on the vehicle model information, the information about parts and/or materials, the part assembly information and the like stored in the product database 2211.

The disassembly-target parts to be disassembled are shown by names of the parts, for example, a part A (for example, secondary battery), a part B (for example, car navigation apparatus), and a part C (for example, catalyst for purification of exhaust gas) of vehicle. The disassembly procedure for the disassembly work is shown, for example, by a procedure such as “remove part C->remove part A->remove part B”.

By making a judgment about whether recovery is to be performed or not, the recommended disassembly-target part decider 213 decides the disassembly-target parts to be disassembled in the disassembly work and/or the disassembly procedure for the disassembly work so that the total of resource prices for parts that can be disassembled per predetermined time is high.

Furthermore, the recommended disassembly-target part decider 213 notifies workers of a purchase price for the parts that can be disassembled per predetermined time by the subsequent disassembly work or that the purchase price for the parts that can be disassembled per predetermined time has become equal to or lower than a predetermined price, by an image outputted from the display apparatus 4, a sound outputted from a sound outputter (not shown) or the like.

The recommended disassembly-target part displayer 214 displays the disassembly-target parts and/or the disassembly procedure decided by the recommended disassembly-target part decider 213 to the workers who are to perform the disassembly work, by the display apparatus 4.

For example, when a part of an article that is being disassembled is visually confirmed by a worker equipped with AR goggles as the display apparatus 4, the recommended disassembly-target part displayer 214 may display the disassembly-target parts to be disassembled in the disassembly work and/or the disassembly procedure for the disassembly work decided by the recommended disassembly-target part decider 213 on the AR goggles in such a manner as to superimpose the disassembly-target parts and/or the disassembly procedure on the part of the article that is being disassembled, by projection mapping.

Further, the recommended disassembly-target part displayer 214 may acquire material grades of the disassembly-target parts to be disassembled, recovery amounts of materials, working hours, recovery profits of the materials and the like from the product database 2211 of the recycling database 221 and display them on the display apparatus 4 together with the disassembly-target parts to be disassembled and/or the disassembly procedure. Furthermore, when the material value per certain time becomes equal to or lower than a predetermined value, the recommended disassembly-target part displayer 214 may display that the work is to be ended, on the display apparatus 4.

The disassembled part identifier 215 identifies parts disassembled by workers. For example, the disassembled part identifier 215 acquires images of or identification information (for example, barcodes, serial numbers or the like) about the parts that have been disassembled by the workers, by the imager or scanner of the terminal apparatus 3, and identifies the parts that have been disassembled, based on the acquired images or identification information about the parts.

Then, if the parts identified by the disassembled part identifier 215 are different from the disassembled part displayed by the recommended disassembly-target part displayer 214, the recommended disassembly-target part decider 213 newly decides the subsequent disassembly-target parts or disassembly procedure.

For example, if the part A identified by the disassembled part identifier 215 is different from the part B displayed by the recommended disassembly-target part displayer 214, the recommended disassembly-target part decider 213 newly decides the subsequent disassembly-target parts or disassembly procedure in consideration of the part B having being disassembled instead of the part A.

Further, the recommended disassembly-target part decider 213 may correct the working hours required to remove each of parts by at least one selected from equipment of workers, the number of the workers, and a degree of skills of the workers that have been inputted by the terminal apparatus 3.

Specifically, when the equipment of the workers includes equipment that improves workability of disassembly work, when the number of the workers is larger than the assumed number of workers for the disassembly work, or when the degree of skills of the workers is higher than a predetermined degree of skills, the recommended disassembly-target part decider 213 corrects the working hours required to remove each of the parts to hours fewer than standard working hours.

When the equipment of the workers includes equipment that is not suitable for the disassembly work, when the number of the workers is smaller than the assumed number of workers for the disassembly work, or when the degree of skills of the workers is lower than the predetermined degree of skills, the recommended disassembly-target part decider 213 corrects the working hours required to remove each of the parts to hours more than the standard working hours.

Furthermore, the recommended disassembly-target part decider 213 may decide the disassembly-target parts to be disassembled and/or the disassembly procedure for the disassembly work, based on the degree of difficulty of removal work for each part stored in the product database 2211.

For example, when the degree of difficulty of removal work for a part of an article judged by the article identifier 211 is relatively high, for example, the weight of the part is so heavy that a load on workers is increased, the workers get dirty at the time of removing the part, or the work for removing the part is complicated, the recommended disassembly-target part decider 213 may make a judgment about whether material recovery is to be performed for the part of the article, using a value obtained by subtracting a predetermined value from the judgment value X about whether recovery is to be performed or not. Thereby, the recommended disassembly-target part decider 213 can deprioritize disassembly work for the part with a high degree of difficulty of removal work.

Further, when parts identified by the disassembled part identifier 215 are different from disassembly-target parts displayed by the recommended disassembly-target part displayer 214, the recommended disassembly-target part decider 213 feeds back, if a total of purchase prices for parts obtained by disassembly work is higher than a value of purchase prices for parts decided before the work, the decided disassembly-target parts and working hours to decision of the subsequent disassembly-target parts and/or disassembly procedure for disassembly work.

For example, if the degree of disassembly work skills of workers is high, the total of the purchase prices for the parts obtained by disassembly work may be higher than the value of the purchase prices for the parts decided before the work. In such a case, the recommended disassembly-target part decider 213 feeds back the disassembled parts obtained by the disassembly work and/or the disassembly procedure to decision of the subsequent disassembly-target parts and/or disassembly procedure for disassembly work.

For example, for the purpose of feedback to the decision of the subsequent disassembly-target parts and/or disassembly procedure for disassembly work, the recommended disassembly-target part decider 213 stores the disassembled parts obtained by the disassembly work and/or working hours required for the disassembly procedure into the storage 22 as the feedback information 222.

The feedback information 222 may be stored into the storage of the terminal apparatus 3, a disassembly work supporting application program operating in the terminal apparatus 3, a website capable of communicating with the work support apparatus 2, a cloud server capable of communicating with the work support apparatus 2 or the like, instead of the storage 22.

Furthermore, the feedback information 222 includes viewer evaluations that are evaluations of the fed-back disassembled parts and disassembly procedure, and of the stored disassembled parts and disassembly procedure, by a viewer. The recommended disassembly-target part displayer 214 preferentially displays disassembly-target parts and/or a disassembly procedure with a relatively high viewer evaluation value in the feedback information 222, on the display apparatus 4.

For example, the recommended disassembly-target part displayer 214 displays the disassembly-target parts and/or disassembly procedure with a relatively high viewer evaluation value, on the upper side of a list of the disassembly-target parts and/or disassembly procedures on the display apparatus 4.

The recommended disassembly-target part decider 213 may decide which part of which article to be recycled are to be disassembled, based on a predetermined unit time amount (for example, one day, one week or the like), identification information about all articles to be recycled for which disassembly work can be performed in the predetermined unit time amount, and at least one selected from equipment of, the number of, and a degree of skills of the workers.

Specifically, the article identifier 211 collectively acquires pieces of external appearance information and/or identification information about articles constituting a plurality of vehicles to be recycled, by the imager or scanner of the terminal apparatus 3. The article identifier 211 identifies kinds of articles for all the vehicles for which disassembly work can be started, based on the acquired pieces of external appearance information and/or identification information about the articles.

Then, the recommended disassembly-target part decider 213 decides which part of which article to be recycled, based on pieces of identification information about all articles to be recycled, for the plurality of vehicles, and at least one selected from the equipment of, the number of, and the degree of skills of workers. Thereby, the article identifier 211 can identify all the articles to be disassembled per unit time, and the recommended disassembly-target part decider 213 can decide all the articles to be disassembled per unit time.

The sending destination decider 216 decides a sending destination of each of parts, based on the kinds of the parts identified by the disassembled part identifier 215, the amounts of the materials of the parts stored in the recycling database 221, and a requested sending amount of each material that can be sent into each of one or more sending destinations, and displays the decided sending destination of the part to the workers by the display apparatus 4.

Here, another display apparatus 4 may be provided separately from the above-stated display apparatus 4 to display disassembly-target parts to be disassembled and/or a disassembly procedure, and may be arranged at or near the part sending destinations. Alternatively, the display apparatus 4 may also be used as the display apparatus 4 to display disassembly-target parts to be disassembled and/or a disassembly procedure.

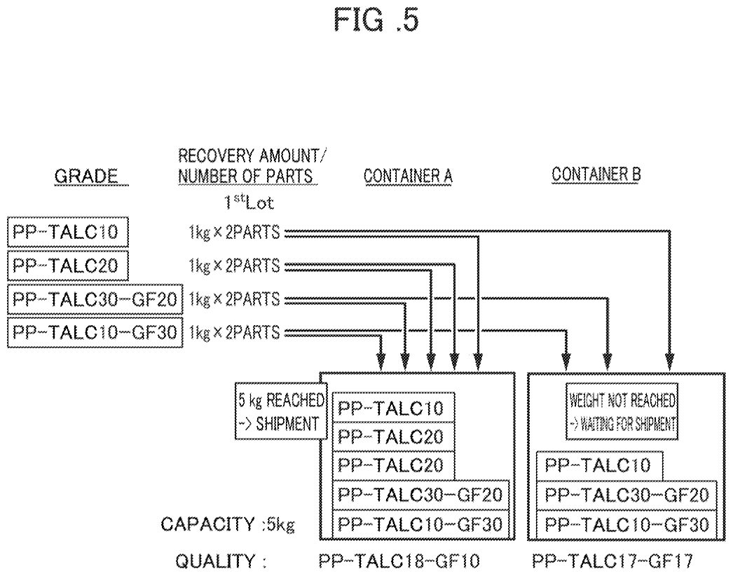

FIG. 5 is a diagram showing an example of sending parts into two containers A and B as part sending destinations. In the example shown in FIG. 5, the sending destination decider 216 decides sending destinations in the case of sending parts including four grades of material (polypropylene (PP)) into the two containers A and B as the 1st lot.

Four pairs of parts, including four material grades of polypropylene (PP), respectively, have been recovered, each part including 1 kg polypropylene (PP). In FIG. 5, “PP-TALC30-GF30” indicates that polypropylene (PP) contains 30% talc and 30% glass fiber (GF).

The acceptable amount of polypropylene (PP) of each of the containers A and B is 5 kg. When the weight of polypropylene (PP) included in sent-in parts reaches 5 kg, the blocks can be shipped. The rates of materials of polypropylene to be sent in are specified for each of the containers A and B. The material rates for the container A are TALC18-GF10, and the material rates for the container B are TALC17-GF17.

The sending destination decider 216 acquires the kind of the material of the parts as described above, an amount of the material of the part, and a requested sending amount from the product database 2211, and decides the container A or B as a sending destination of each parts as shown in FIG. 5 based on the kind of the material of the parts, the amount of the material of the part, and the requested sending amount. As a result, since the weight and the material rates for the container A satisfy shipment conditions, shipment is performed. On the other hand, since the weight and the material rates for the container B do not satisfy the shipment conditions, shipment is not performed, and the container B is in a shipment waiting state.

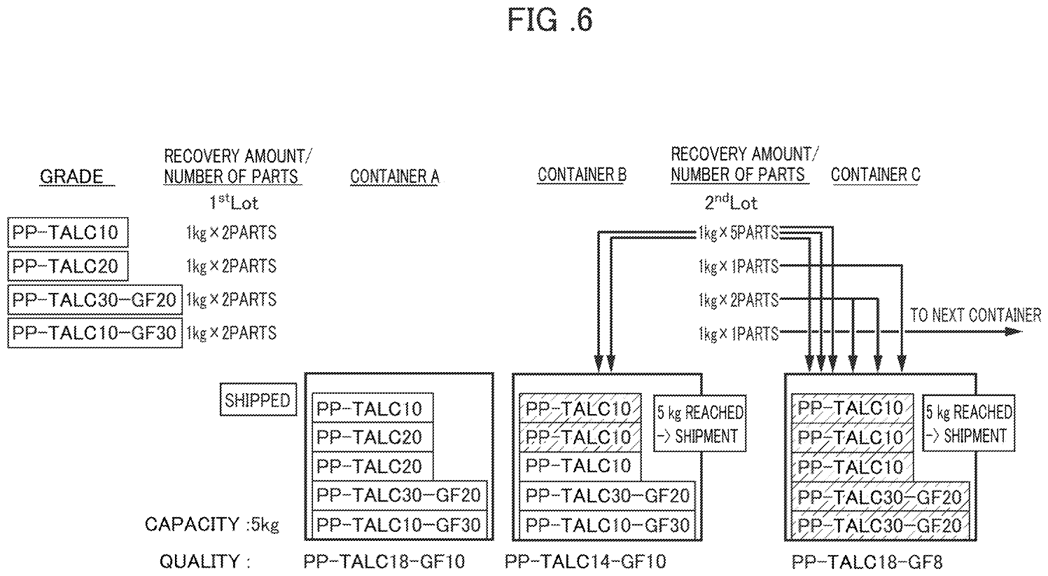

FIG. 6 is a diagram showing an example of sending parts into two containers B and C as part sending destinations. In the example shown in FIG. 6, the sending destination decider 216 decides sending destinations in the case of sending parts including four grades of material (polypropylene (PP)) into the two containers B and C as the 2nd lot.

Similarly to the example shown in FIG. 5, the sending destination decider 216 acquires the kind of the material of the parts, an amount of the material of the part, and a requested sending amount from the product database 2211, and decides the container B or C as a sending destination of each parts as shown in FIG. 6 based on the kind of the material of the parts, the amount of the material of the part, and the requested sending amount. As a result, since the weights and the material rates for the containers B and C satisfy the shipment condition, shipment is performed. Surplus material parts corresponding to surplus material are sent into the next container.

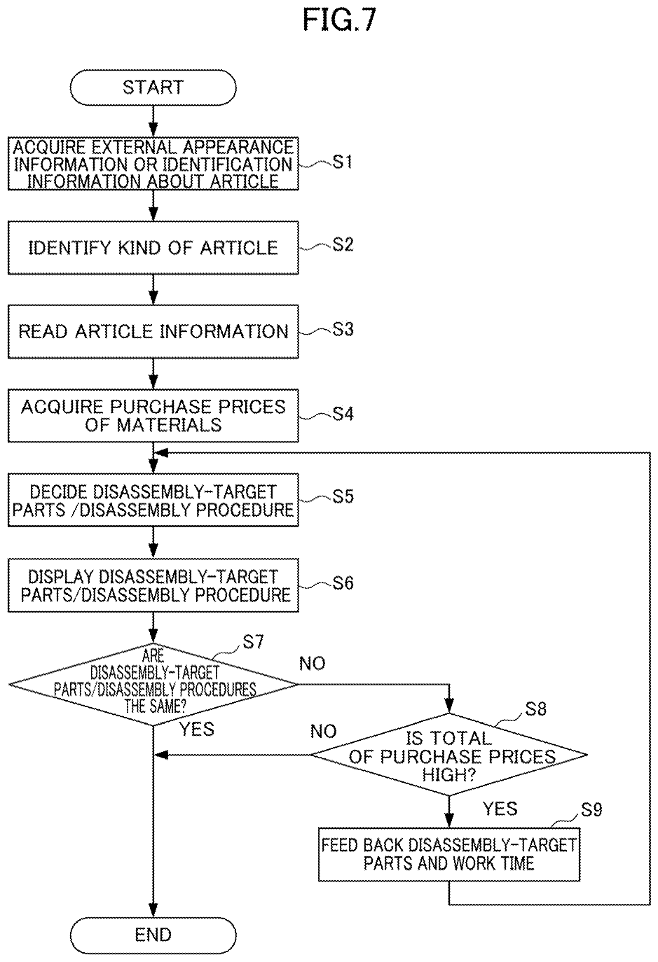

FIG. 7 is a flowchart showing a process of the work support apparatus 2 according to the present embodiment. At step S1, the terminal apparatus 3 acquires external appearance information and/or identification information about an article to be recycled and transmits the external appearance information and/or the identification information to the work support apparatus 2. The article identifier 211 acquires the external appearance information and/or identification information about the article to be recycled, from the terminal apparatus 3.

At step S2, the article identifier 211 identifies the kind of the article based on the acquired external appearance information and/or identification information about the article.

At step S3, the recommended disassembly-target part decider 213 reads article information about the article identified by the article identifier 211, including parts of the article, materials of the parts, amounts of the materials and working hours required to remove each of the parts, from the product database 2211.

At step S4, the material price acquirer 212 acquires purchase prices of the materials of the parts of the article, and stores the acquired purchase prices of the materials into the material price database 2212.

At step S5, the recommended disassembly-target part decider 213 decides disassembly-target parts to be disassembled in disassembly work and/or a disassembly procedure for the disassembly work so that a total of resource prices for parts that can be disassembled per predetermined time is high, based on the purchase prices of materials, recovery amounts of the materials, and working hours for disassembly work stored in the product database 2211.

At step S6, the recommended disassembly-target part displayer 214 displays the disassembly-target parts to be disassembled and/or disassembly procedure decided by the recommended disassembly-target part decider 213 to workers who are to perform the disassembly work, by the display apparatus 4.

At step S7, the recommended disassembly-target part decider 213 judges whether parts identified by the disassembled part identifier 215 are the same as the disassembly-target parts displayed by the recommended disassembly-target part displayer 214 or not. If the parts are the same (YES), the process then ends. On the other hand, if the parts are different (NO), the process proceeds to step S8.

At step S8, the recommended disassembly-target part decider 213 judges whether or not a total of purchase prices for parts obtained by the disassembly work is higher than the value of purchase prices for the parts decided before the work. If the total of the purchase prices for the parts obtained by the disassembly work is higher than the value of the purchase prices for the parts decided before the work (YES), the process proceeds to step S9. On the other hand, if the total of the purchase prices for the parts obtained by the disassembly work is equal or lower than the value of the purchase prices for the parts decided before the work (NO), the process ends after that.

At step S9, the recommended disassembly-target part decider 213 feeds back the decided disassembly-target parts and working hours to decision of the subsequent disassembly-target parts to be disassembled and/or disassembly procedure for disassembly work, that is, to the process of step S5. Then, at step S5, the recommended disassembly-target part decider 213 newly decides the subsequent disassembly-target parts to be disassembled and/or disassembly procedure.

As described above, the recycling work support system 1 according to the present embodiment includes: the article identifier 211 identifying the kind of an article to be recycled, based on external appearance information and/or identification information about the article; the recycling database 221 storing article information about the article identified by the article identifier 211, the article information including parts of the article, materials of the parts, amounts of the materials, and working hours required to remove each of the parts; the material price acquirer 212 acquiring resource prices of the materials of the parts; the recommended disassembly-target part decider 213 deciding disassembly-target parts to be disassembled in disassembly work and/or a disassembly procedure for the disassembly work so that a total of resource prices for parts that can be disassembled per predetermined time is high, based on the resource prices of the materials, recovery amounts of the materials, and the working hours; and the recommended disassembly-target part displayer 214 displaying the decided disassembly-target parts to be disassembled and/or disassembly procedure to workers who are to perform the disassembly work.

Due to the above configuration, the recycling work support system 1 can improve the total amount of values of parts obtained within time resources that can be used for one article to be recycled and enable recycling to be smoothly performed.

Furthermore, the recommended disassembly-target part decider 213 notifies workers of a purchase price for the parts that can be disassembled per predetermined time by the subsequent disassembly work or that the purchase price for the parts that can be disassembled per predetermined time has become equal to or lower than a predetermined price, by an image outputted from the display apparatus 4 or a sound outputted from a sound outputter (not shown) or the like. Due to the above configuration, the recycling work support system 1 can improve a total amount of obtained values of parts by equipment of workers, limited time resources, and the like, for example, by, after finishing current disassembly of an article to be recycled, starting disassembly of another article to be recycled.

The disassembled part identifier 215 identifies parts that have been disassembled by workers. For example, the disassembled part identifier 215 acquires an image of or identification information (for example, a barcode, a serial number or the like) about each part that has been disassembled by the workers, by the imager or scanner of the terminal apparatus 3, and identifies the part that has been disassembled, based on the acquired image or identification information about the part. Then, if the part identified by the disassembled part identifier 215 is different from a disassembly-target part displayed by the recommended disassembly-target part displayer 214, the recommended disassembly-target part decider 213 newly decides the subsequent disassembly-target parts or disassembly procedure. Due to the above configuration, the recycling work support system 1 can continue support of work even when different work has been done at workers' discretion.

Further, the recommended disassembly-target part decider 213 may correct the working hours required to remove each of parts by at least one selected from equipment of workers, the number of the workers, and a degree of skills of the workers that have been inputted by the terminal apparatus 3. Due to the above configuration, the recycling work support system 1 can improve the accuracy of prediction of the total amount of values of parts obtained within limited time resources.

Furthermore, the recommended disassembly-target part decider 213 may decide the disassembly-target parts to be disassembled and/or the disassembly procedure for the disassembly work, based on the degree of difficulty of removal work for each part stored in the product database 2211. Due to the above configuration, the recycling work support system 1 can reconcile improvement of the total amount of obtained values of parts with improvement of workability.

Further, when parts identified by the disassembled part identifier 215 are different from disassembly-target parts displayed by the recommended disassembly-target part displayer 214, the recommended disassembly-target part decider 213 feeds back, if a total of purchase prices for parts obtained by disassembly work is higher than a value of purchase prices for parts decided before the work, the decided disassembly-target parts and working hours to decision of the subsequent disassembly-target parts and/or disassembly procedure for disassembly work. Due to the above configuration, the recycling work support system 1 can improve the total amount of obtained values of parts.

Furthermore, the feedback information 222 stores viewer evaluations that are evaluations of the fed-back disassembly-target parts and disassembly procedure, and of the stored disassembly-target parts and disassembly procedure, by a viewer. The recommended disassembly-target part displayer 214 preferentially displays disassembly-target parts to be disassembled and/or a disassembly procedure with a relatively high viewer evaluation value in the feedback information 222, on the display apparatus 4. Due to the above configuration, the recycling work support system 1 can contribute to improvement of skills of a user of the recycling work support system 1 and improve the total amount of obtained values of parts.

The recommended disassembly-target part decider 213 may decide which part of which article to be recycled are to be disassembled, based on a predetermined unit time amount (for example, one day, one week or the like), identification information about all articles to be recycled for which disassembly work can be performed in the predetermined unit time amount, and at least one selected from equipment of, the number of, and a degree of skills of the workers. Due to the above configuration, even within time resources that can be used for one article to be recycled, the recycling work support system 1 can improve the accuracy of the total amount of values by calculating the total amount of values of parts obtained within unit time by group.

The sending destination decider 216 decides a sending destination of each of parts, based on the kinds of the parts identified by the disassembled part identifier 215, the amounts of the materials of the parts stored in the recycling database 221, and a requested sending amount of each material that can be sent into each of one or more sending destinations, and displays the decided sending destination of the part to the workers by the display apparatus 4. Due to the above configuration, the recycling work support system 1 can enable recycling to be smoothly performed by adjusting materials obtained from disassembled parts to be close to materials that meet demand.

An embodiment of the present invention has been described above. The present invention, however, is not limited thereto. Detailed configurations may be appropriately changed within the spirit of the present invention.

### EXPLANATION OF REFERENCE NUMERALS

1: Recycling work support system
2: Work support apparatus
3: Terminal apparatus
4: Display apparatus
21: Controller
22: Storage
23: Communicator
24: Inputter
25: Display
211: Article identifier
212: Material price acquirer
213: Recommended disassembly-target part decider
214: Recommended disassembly-target part displayer
215: Disassembled part identifier
216: Sending destination decider
221: Recycling database (article information storage)
222: Feedback information (Feedback information storage)
2211: Product database
2212: Material price database

What is claimed is:

1. A recycling work support system comprising:
an article identifier configured to identify a kind of an article to be recycled, based on external appearance information and/or identification information about the article;
an article information storage configured to store article information about the article identified by the article identifier, the article information including parts of the article, materials of the parts, amounts of the materials, and working hours required to remove each of the parts;
a material price acquirer configured to acquire resource prices of the materials of the parts;
a recommended disassembly-target part decider configured to decide disassembly-target parts to be disassembled in disassembly work and/or a disassembly procedure for the disassembly work so that a total of resource prices for parts that can be disassembled per predetermined time is high, based on the resource prices of the materials, recovery amounts of the materials, and the working hours; and
a recommended disassembly-target part displayer configured to display the decided disassembly-target parts and/or disassembly procedure to workers who perform the disassembly work.

2. The recycling work support system according to claim 1, wherein the recommended disassembly-target part decider notifies a purchase price for the parts that can be disassembled per predetermined time by subsequent disassembly work or notifies that the purchase price for the parts that can be disassembled per predetermined time has become equal to or lower than a predetermined value.

3. The recycling work support system according to claim 1, further comprising:
a disassembled part identifier configured to identify parts disassembled by the workers, wherein in a case where the parts identified by the disassembled part identifier are different from the disassembly-target parts or disassembly procedure displayed by the recommended disassembly-target part displayer, the recommended disassembly-target part decider newly decides subsequent disassembly-target parts or disassembly procedure.

4. The recycling work support system according to claim 1, wherein the recommended disassembly-target part decider corrects the working hours required to remove each of the parts based on at least one selected from equipment of the workers, a number of the workers and a degree of skills of the workers.

5. The recycling work support system according to claim 1, wherein the recommended disassembly-target part decider decides the disassembly-target parts and/or the disassembly procedure for the disassembly work further based on a degree of difficulty of removal work for each of the parts.

6. The recycling work support system according to claim 1, wherein, in a case where a total of purchase prices for parts obtained by the disassembly work is higher than a decided value, the recommended disassembly-target part decider feeds back the disassembly-target parts and the working hours to decision of subsequent disassembly-target parts and/or disassembly procedure for disassembly work.

7. The recycling work support system according to claim 6, further comprising:
a feedback information storage configured to store viewer evaluations that are evaluations by a viewer about the disassembly-target parts and the disassembly procedure fed back and the disassembly-target parts and the disassembly procedure stored, wherein the recommended disassembly-target part displayer preferentially displays disassembly-target parts and/or a disassembly procedure with a relatively high value of the viewer evaluation.

8. The recycling work support system according to claim 1, wherein the recommended disassembly-target part decider decides which parts of which article to be recycled are to be disassembled, based on a predetermined unit time amount, identification information about all articles to be recycled for which disassembly work can be performed in the predetermined unit time amount, and at least one selected from equipment of, a number of, and a degree of skills of the workers.

9. The recycling work support system according to claim 3, further comprising:
a sending destination decider configured to decide, based on kinds of the parts identified by the disassembled part identifier, the amounts of the materials of the parts stored in the article information storage, and a requested sending amount of each material that can be sent into each of one or more sending destinations, a sending destination of each of the parts, and display the decided sending destination of the part to the workers.
